(19) United States
(12) Patent Application Publication
(10) Pub. No.: US 2014/0302365 A1
(43) Pub. Date: Oct. 9, 2014

(54) Electrode Assembly of Secondary Battery

(71) Applicant: SK Innovation Co., Ltd., Seoul (KR)

(72) Inventors: Hee Chan Park, Daejeon (KR); Sang Bum Kim, Daejeon (KR)

(73) Assignee: SK Innovation Co., Ltd., Seoul (KR)

(21) Appl. No.: 14/247,444

(22) Filed: Apr. 8, 2014

(30) Foreign Application Priority Data
Apr. 9, 2013 (KR) 10-2013-0038421

(51) Int. Cl. H01M 10/04

(52) U.S. Cl. CPC H01M 10/0431
USPC 429/94

(57) ABSTRACT

There is provided an electrode assembly of a secondary battery in which first and second electrode plates are sequentially stacked, a first separator is interposed between the first and second electrode plates, and the first and second electrode plates and the first separator are wound. The first electrode plate has one surface on which first electrode tabs are formed and an other surface on which the first electrode tabs are not formed, the second electrode plate has one surface on which second electrode tabs are formed and an other surface on which the second electrode tabs are not formed, and the first and second electrode plates further include a stacking surface formed between one surface and the other surface thereof and having a width increased by a predetermined interval whenever they are wound.

### CROSS-REFERENCE TO RELATED APPLICATION

This application claims priority to Korean Patent Application No. 10-2013-0038421, filed Apr. 9, 2013, the disclosure of which is hereby incorporated in its entirety by reference.

### TECHNICAL FIELD

The following disclosure relates to an electrode assembly of a secondary battery capable of being charged or discharged.

### BACKGROUND

Research into a secondary battery capable of being charged and discharged unlike a primary battery has been actively conducted in accordance with the development of state-of-the-art fields such as a digital camera, a cellular phone, a laptop computer, a hybrid vehicle, and the like. An example of the secondary battery includes a nickel-cadmium battery, a nickel-metal hydride battery, a nickel-hydrogen battery, a lithium secondary battery, and the like.

A scheme of manufacturing an electrode assembly of the secondary battery as described above is mainly divided into two schemes. A small secondary battery has been mainly manufactured in a jelly-roll form by disposing a cathode plate and an anode plate on a separator, and winding the cathode plate, the anode plate, and the separator.

Meanwhile, recently, the cathode plate and the anode plate have included a plurality of electrode plates in order to charge or discharge a large amount of current. However, since the electrode assembly is formed by winding the cathode plate, the anode plate, and the separator, it is not easy to overlap a plurality of cathode tabs and a plurality of anode tabs with each other at a desired position.

In order to solve this problem, US2011-0067227 A1 has suggested a method of manufacturing an electrode assembly for a rechargeable battery including: providing a first electrode plate including a first active material portion coated with a first active material and a plurality of first inactive portions disposed at one side of the first active material portion so as to be spaced apart from each other; preparing a second electrode plate including a second active material portion coated with a second active material and a plurality of second inactive portions disposed at one side of the second active material portion so as to be spaced apart from each other; preparing a separator; winding the first electrode plate, the second electrode plate, and the separator, the separator being interposed between the first and second electrode plates; and removing non-overlapped portions of the first inactive portions and non-overlapped portions of the second inactive portions to form first and second electrode tab groups for the first and second electrode plates, respectively.

However, in the related art, in a process of removing the non-overlapped portions of the first inactive portions and the non-overlapped portions of the second inactive portions, the removed materials may intrude between the first electrode plate, the separator, and the second electrode plates, respectively.

Therefore, the development of various electrode assemblies of a secondary battery for solving the above-mentioned problem has been demanded.

### RELATED ART DOCUMENT

### Patent Document

US 20110067227 A1 (2011.03.24)

### SUMMARY

An embodiment of the present invention is directed to providing an electrode assembly of a secondary battery capable of stacking first and second electrode tabs at designed positions, respectively, without a process of removing non-overlapped portions of the first and second electrode tables.

In one general aspect, there is provided an electrode assembly of a secondary battery in which first and second electrode plates are sequentially stacked, a first separator is interposed between the first and second electrode plates, and the first and second electrode plates and the first separator are wound, wherein the first electrode plate has one surface on which first electrode tabs are formed and the other surface on which the first electrode tabs are not formed, the second electrode plate has one surface on which second electrode tabs are formed and the other surface on which the second electrode tabs are not formed, and the first and second electrode plates further include a stacking surface formed between one surface and the other surface thereof and having a width increased by a predetermined interval whenever they are wound.

The first electrode tabs and the second electrode tabs may be disposed on the same surfaces so as to be spaced apart from each other by a predetermined interval.

The first electrode tabs and the second electrode tabs may be disposed on different surfaces so as to be spaced apart from each other by a predetermined interval.

The first electrode tabs and the second electrode tabs may be disposed in different directions on the same surfaces so as to be spaced apart from each other by a predetermined interval.

The first electrode tabs and the second electrode tabs may be disposed in opposite directions on different surfaces so as to be spaced apart from each other by a predetermined interval.

A start position X at which the first electrode tab may be formed in the first electrode plate is determined by the following Equation 1, and a start position Y at which the second electrode tab may be formed in the second electrode plate is determined by the following Equation 2:

X=nw+nt+d (n=0 to n) (Equation 1)

Y=mw+mt+(w−W2−d′) (m=0 to m) (Equation 2)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface formed at the time of initially winding electrode assembly of secondary battery to final position at which initial second electrode tab is formed
W2: width of second electrode tab
n, m: the number of windings.

A start position X at which the first electrode tab may be formed in the first electrode plate is determined by the following Equation 3, and a start position Y at which the second electrode tab may be formed in the second electrode plate is determined by the following Equation 4:

X=floor([nw+nt+d]/k) (n=0 to n) (Equation 3)

Y=floor([mw+mt+(w−W2−d′)]/k) (m=0 to m) (Equation 4)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

A start position X at which the first electrode tab may be formed in the first electrode plate is determined by the following Equation 5, and a start position Y at which the second electrode tab may be formed in the second electrode plate is determined by the following Equation 6:

X=ceil([nw+nt+d]/k) (n=0 to n) (Equation 5)

Y=ceil([mw+mt+(w−W2−d′)]/k) (m=0 to m) (Equation 6)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

A start position X at which the first electrode tab may be formed in the first electrode plate is determined by the following Equation 7, and a start position Y at which the second electrode tab may be formed in the second electrode plate is determined by the following Equation 8:

X=floor([nw+nt+d]/k) (n=n to 0) (Equation 7)

Y=floor([mw+mt+(w−W2−d′)]/k) (m=m to 0) (Equation 8)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

A start position X at which the first electrode tab may be formed in the first electrode plate is determined by the following Equation 9, and a start position Y at which the second electrode tab may be formed in the second electrode plate is determined by the following Equation 10:

X=ceil([nw+nt+d]/k) (n=n to 0) (Equation 9)

Y=ceil([mw+mt+(w−W2−d′)]/k) (m=m to 0) (Equation 10)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

A start position X at which the first electrode tab may be formed in the first electrode plate is determined by the following Equation 11, and a start position Y at which the second electrode tab may be formed in the second electrode plate is determined by the following Equation 12:

X=nw+nt+d (n=0 to n) (Equation 11)

Y=mw+mt+(w−W2−d′) (m=1 to m) (Equation 12)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings.

A start position X at which the first electrode tab may be formed in the first electrode plate is determined by the following Equation 13, and a start position Y at which the second electrode tab may be formed in the second electrode plate is determined by the following Equation 14:

X=floor([nw+nt+d]/k) (n=0 to n) (Equation 13)

Y=floor([mw+mt+(w−W2−d′)]/k) (m=1 to m) (Equation 14)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

A start position X at which the first electrode tab may be formed in the first electrode plate is determined by the following Equation 15, and a start position Y at which the second electrode tab may be formed in the second electrode plate is determined by the following Equation 16:

X=ceil([nw+nt+d]/k) (n=0 to n) (Equation 15)

Y=ceil([mw+mt+(w−W2−d′)]/k) (m=1 to m) (Equation 16)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

A start position X at which the first electrode tab may be formed in the first electrode plate is determined by the following Equation 17, and a start position Y at which the second electrode tab may be formed in the second electrode plate is determined by the following Equation 18:

X=floor([nw+nt+d]/k) (n=n to 0) (Equation 17)

Y=floor([mw+mt+(w−W2−d′)]/k) (m=m to 1) (Equation 18)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

A start position X at which the first electrode tab may be formed in the first electrode plate is determined by the following Equation 19, and a start position Y at which the second electrode tab may be formed in the second electrode plate is determined by the following Equation 20:

X=ceil([nw+nt+d]/k) (n=n to 0) (Equation 19)

Y=ceil([mw+mt+(w−W2−d′)]/k) (m=m to 1) (Equation 20)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

### BRIEF DESCRIPTION OF THE DRAWINGS

FIG. 1 is a side view of an electrode assembly of a secondary battery according to a first exemplary embodiment of the present invention.

FIG. 2 is a side view of an electrode assembly of a secondary battery according to a second exemplary embodiment of the present invention.

FIG. 3 is a side view of an electrode assembly of a secondary battery according to a third exemplary embodiment of the present invention.

FIG. 4 is a side view of an electrode assembly of a secondary battery according to a fourth exemplary embodiment of the present invention.

### DETAILED DESCRIPTION OF MAIN ELEMENTS

100: Electrode assembly of secondary battery according to exemplary embodiment of the present invention
110: First electrode tab
120: Second electrode tab

### DETAILED DESCRIPTION OF EMBODIMENTS

Hereinafter, a technical idea of the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

In an electrode assembly of a secondary battery according to an exemplary embodiment of the present invention, first and second electrode plates are sequentially stacked, a first separator is interposed between the first and second electrode plates, and the first and second electrode plates and the first separator are wound.

The first electrode plate has one surface on which a plurality of first electrode tabs are formed and the other surface on which the first electrode tabs are not formed.

The second electrode plate has one surface on which a plurality of second electrode tabs are formed and the other surface on which the second electrode tabs are not formed.

Here, the electrode assembly of a secondary battery further includes a stacking surface having a width increased by a predetermined interval whenever it is wound.

In more detail, the electrode assembly of a secondary battery is stacked in a first surface/stacking surface/second surface when it is wound once, is stacked in a first surface/stacking surface/second surface/stacking surface/third surface when it is wound twice, is stacked in a first surface/stacking surface/second surface/stacking surface/third surface/stacking surface/fourth surface when it is wound three times, is stacked in a first surface/stacking surface/second surface/stacking surface/third surface/stacking surface/fourth surface/stacking surface/fifth surface when it is wound four times, and so on.

### First Exemplary Embodiment

In an electrode assembly of a secondary battery according to a first exemplary embodiment of the present invention, first electrode tabs and second electrode tabs may be disposed on the same surfaces so as to be spaced apart from each other by a predetermined interval. In more detail, the first electrode tabs and the second electrode tabs may be disposed on one side of a first surface, one side of a third surface, one side of a fifth surface, and so on, so as to be spaced apart from each other by a predetermined interval.

Here, a start position X at which the first electrode tab is formed in the first electrode plate may be determined by the following Equation 1, and a start position Y at which the second electrode tab is formed in the second electrode plate may be determined by the following Equation 2:

X=nw+nt+d (n=0 to n) (Equation 1)

Y=mw+mt+(w−W2−d′) (m=0 to m) (Equation 2)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface formed at the time of initially winding electrode assembly of secondary battery to final position at which initial second electrode tab is formed
W2: width of second electrode tab
n, m: the number of windings.

Here, w means a width of an electrode assembly of a secondary battery wound at a predetermined interval, in a winding direction, t means a distance from a start position of a first electrode plate to a start position at which an initial first electrode tab is formed, in the winding direction, d′ means a distance from a start position of an initial stacking surface formed at the time of initially winding the electrode assembly of a secondary battery to a final position at which an initial second electrode tab is formed, in the winding direction, W2 means a width of the second electrode tab in the winding direction, n means the number of windings of a first electrode plate, and m indicates the number of windings of a second electrode plate.

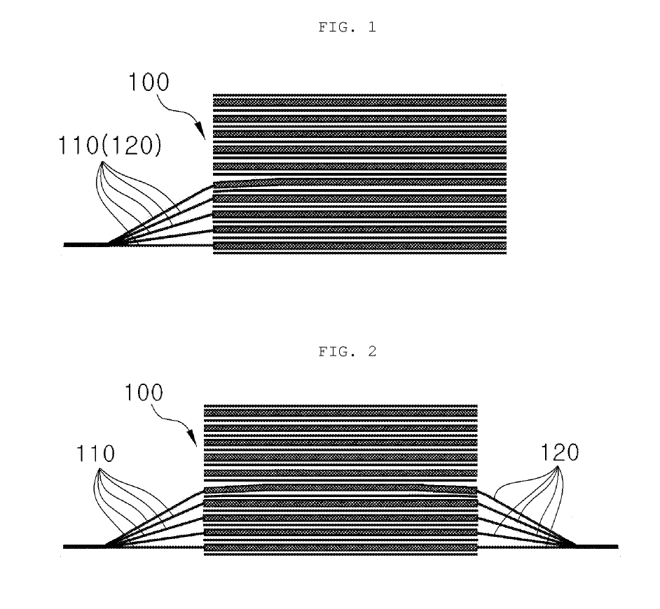

The electrode assembly 100 of a secondary battery wound by the above Equation 1 and 2 is wound from one side thereof in a length direction, and is wound in a structure in which the first electrode tabs 110 and the second electrode tabs 120 are overlapped with each other on lower sides of one surfaces thereof, respectively, as shown in FIG. 1.

However, in the electrode assembly of a secondary battery wound by the above Equations 1 and 2, both of the values of X and Y may descend to a decimal point or less.

In addition, a start position X at which the first electrode tab is formed in the first electrode plate may be determined by the following Equation 3 in the first electrode plate, and a start position Y at which the second electrode tab is formed in the second electrode plate may be determined by the following Equation 4:

X=floor([nw+nt+d]/k) (n=0 to n) (Equation 3)

Y=floor([mw+mt+(w−W2−d′)]/k) (m=0 to m) (Equation 4)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

The electrode assembly 100 of a secondary battery wound by the above Equation 3 and 4 is also wound from one side thereof in a length direction, and is wound in a structure in which the first electrode tabs 110 and the second electrode tabs 120 are overlapped with each other on lower sides of one surfaces thereof, respectively, as shown in FIG. 1.

Here, in the electrode assembly of a secondary battery wound by the above Equations 3 and 4, since both of the values of X and Y are integers, it is easy to adjust a dimension.

In addition, a start position X at which the first electrode tab is formed in the first electrode plate may be determined by the following Equation 5, and a start position Y at which the second electrode tab is formed in the second electrode plate may be determined by the following Equation 6:

X=ceil([nw+nt+d]/k) (n=0 to n) (Equation 5)

Y=ceil([mw+mt+(w−W2−d′)]/k) (m=0 to m) (Equation 6)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

The electrode assembly 100 of a secondary battery wound by the above Equation 5 and 6 is also wound from one side thereof in a length direction, and is wound in a structure in which the first electrode tabs 110 and the second electrode tabs 120 are overlapped with each other on lower sides of one surfaces thereof, respectively, as shown in FIG. 1.

Here, in the electrode assembly of a secondary battery wound by the above Equations 5 and 6, since both of the values of X and Y are integers, it is easy to adjust a dimension.

In addition, a start position X at which the first electrode tab is formed in the first electrode plate may be determined by the following Equation 7, and a start position Y at which the second electrode tab is formed in the second electrode plate may be determined by the following Equation 8:

X=floor([nw+nt+d]/k) (n=n to 0) (Equation 7)

Y=floor([mw+mt+(w−W2−d′)]/k) (m=m to 0) (Equation 8)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

The electrode assembly 100 of a secondary battery wound by the above Equation 7 and 8 is wound from the other side thereof in a length direction, and is wound in a structure in which the first electrode tabs 110 and the second electrode tabs 120 are overlapped with each other on lower sides of one surfaces thereof, respectively, as shown in FIG. 1.

Here, in the electrode assembly of a secondary battery wound by the above Equations 7 and 8, since both of the values of X and Y are integers, it is easy to adjust a dimension.

In addition, a start position X at which the first electrode tab is formed in the first electrode plate may be determined by the following Equation 9, and a start position Y at which the second electrode tab is formed in the second electrode plate may be determined by the following Equation 10:

X=ceil([nw+nt+d]/k) (n=n to 0) (Equation 9)

Y=ceil([mw+mt+(w−W2−d′)]/k) (m=m to 0) (Equation 10)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

The electrode assembly 100 of a secondary battery wound by the above Equation 9 and 10 is wound from the other side thereof in a length direction, and is wound in a structure in which the first electrode tabs 110 and the second electrode tabs 120 are overlapped with each other on lower sides of one surfaces thereof, respectively, as shown in FIG. 1.

Here, in the electrode assembly of a secondary battery wound by the above Equations 9 and 10, since both of the values of X and Y are integers, it is easy to adjust a dimension.

### Second Exemplary Embodiment

In an electrode assembly of a secondary battery according to a second exemplary embodiment of the present invention, first electrode tabs and second electrode tabs may be disposed in opposite directions on the same surfaces so as to be spaced apart from each other by a predetermined interval. In more detail, the first electrode tabs may be disposed on one side of a first surface, one side of a second surface, one side of a third surface, and so on, and the second electrode tabs may be disposed on the other side of the first surface, the other side of the second surface, the other side of the third surface, and so on, so as to be spaced apart from the first electrode tabs, respectively.

Here, the electrode assembly 100 of a secondary battery wound by the above Equation 1 and 2 is wound from one side thereof in a length direction, and is wound in a structure in which the first electrode tabs 110 are overlapped with each other on lower sides of one surfaces thereof and the second electrode tabs 120 are overlapped with each other on lower sides of the other surfaces, as shown in FIG. 2.

However, in the electrode assembly of a secondary battery wound by the above Equations 1 and 2, both of the values of X and Y may descend to a decimal point or less.

In addition, the electrode assembly 100 of a secondary battery wound by the above Equation 3 and 4 is wound from one side thereof in a length direction, and is wound in a structure in which the first electrode tabs 110 are overlapped with each other on lower sides of one surfaces thereof and the second electrode tabs 120 are overlapped with each other on lower sides of the other surfaces, as shown in FIG. 2.

In addition, the electrode assembly 100 of a secondary battery wound by the above Equation 5 and 6 is wound from one side thereof in a length direction, and is wound in a structure in which the first electrode tabs 110 are overlapped with each other on lower sides of one surfaces thereof and the second electrode tabs 120 are overlapped with each other on lower sides of the other surfaces, as shown in FIG. 2.

In addition, the electrode assembly 100 of a secondary battery wound by the above Equation 7 and 8 is wound from the other side thereof in a length direction, and is wound in a structure in which the first electrode tabs 110 are overlapped with each other on lower sides of one surfaces thereof and the second electrode tabs 120 are overlapped with each other on lower sides of the other surfaces, as shown in FIG. 2.

In addition, the electrode assembly 100 of a secondary battery wound by the above Equation 9 and 10 is wound from the other side thereof in a length direction, and is wound in a structure in which the first electrode tabs 110 are overlapped with each other on lower sides of one surfaces thereof and the second electrode tabs 120 are overlapped with each other on lower sides of the other surfaces, as shown in FIG. 2.

Here, in the electrode assembly of a secondary battery wound by the above Equations 3 and 4/5 and 6/7 and 8/9 and 10, since both of the values of X and Y are integers, it is easy to adjust a dimension.

### Third Exemplary Embodiment

In an electrode assembly of a secondary battery according to a third exemplary embodiment of the present invention, first electrode tabs and second electrode tabs may be disposed on the different surfaces so as to be spaced apart from each other by a predetermined interval. In more detail, the first electrode tabs may be disposed on one side of a first surface, one side of a third surface, one side of a fifth surface, and so on, and the second electrode tabs may be disposed on one side of a second surface, one side of a fourth surface, and so on.

Here, a start position X at which the first electrode tab is formed in the first electrode plate may be determined by the following Equation 11, and a start position Y at which the second electrode tab is formed in the second electrode plate may be determined by the following Equation 12:

X=nw+nt+d (n=0 to n) (Equation 11)

Y=mw+mt+(w−W2−d′) (m=1 to m) (Equation 12)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings.

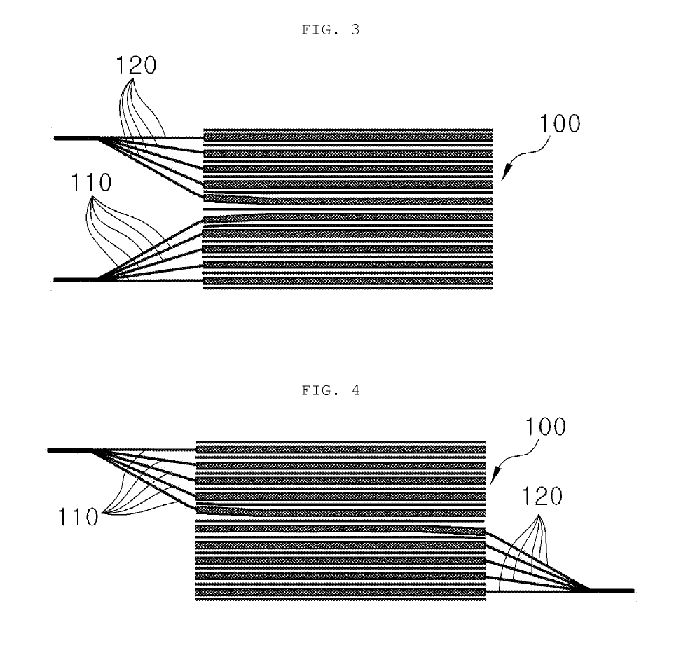

The electrode assembly 100 of a secondary battery wound by the above Equation 11 and 12 is wound from one side thereof in a length direction, and is wound in a structure in which the first electrode tabs 110 are overlapped with each other on lower sides of one surfaces thereof and the second electrode tabs 120 are overlapped with each other on upper sides of one surfaces thereof, as shown in FIG. 3.

However, in the electrode assembly of a secondary battery wound by the above Equations 11 and 12, both of the values of X and Y may descend to a decimal point or less.

In addition, a start position X at which the first electrode tab is formed in the first electrode plate may be determined by the following Equation 13, and a start position Y at which the second electrode tab is formed in the second electrode plate may be determined by the following Equation 14:

X=floor([nw+nt+d]/k) (n=0 to n) (Equation 13)

Y=floor([mw+mt+(w−W2−d′)]/k) (m=1 to m) (Equation 14)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

The electrode assembly 100 of a secondary battery wound by the above Equation 13 and 14 is wound from one side thereof in a length direction, and is wound in a structure in which the first electrode tabs 110 are overlapped with each other on lower sides of one surfaces thereof and the second electrode tabs 120 are overlapped with each other on upper sides of one surfaces thereof, as shown in FIG. 3.

In addition, a start position X at which the first electrode tab is formed in the first electrode plate may be determined by the following Equation 15, and a start position Y at which the second electrode tab is formed in the second electrode plate may be determined by the following Equation 16:

X=ceil([nw+nt+d]/k) (n=0 to n) (Equation 15)

Y=ceil([mw+mt+(w−W2−d′)]/k) (m=1 to m) (Equation 16)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

The electrode assembly 100 of a secondary battery wound by the above Equation 15 and 16 is wound from one side thereof in a length direction, and is wound in a structure in which the first electrode tabs 110 are overlapped with each other on lower sides of one surfaces thereof and the second electrode tabs 120 are overlapped with each other on upper sides of one surfaces thereof, as shown in FIG. 3.

In addition, a start position X at which the first electrode tab is formed in the first electrode plate may be determined by the following Equation 17, and a start position Y at which the second electrode tab is formed in the second electrode plate may be determined by the following Equation 18:

X=floor([nw+nt+d]/k) (n=n to 0) (Equation 17)

Y=floor([mw+mt+(w−W2−d′)]/k) (m=m to 1) (Equation 18)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

The electrode assembly 100 of a secondary battery wound by the above Equation 17 and 18 is wound from the other side thereof in a length direction, and is wound in a structure in which the first electrode tabs 110 are overlapped with each other on lower sides of one surfaces thereof and the second electrode tabs 120 are overlapped with each other on upper sides of one surfaces thereof, as shown in FIG. 3.

In addition, a start position X at which the first electrode tab is formed in the first electrode plate may be determined by the following Equation 19, and a start position Y at which the second electrode tab is formed in the second electrode plate may be determined by the following Equation 20:

X=ceil([nw+nt+d]/k) (n=n to 0) (Equation 19)

Y=ceil([mw+mt+(w−W2−d′)]/k) (m=m to 1) (Equation 20)

w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

The electrode assembly 100 of a secondary battery wound by the above Equation 19 and 20 is wound from the other side thereof in a length direction, and is wound in a structure in which the first electrode tabs 110 are overlapped with each other on lower sides of one surfaces thereof and the second electrode tabs 120 are overlapped with each other on upper sides of one surfaces thereof, as shown in FIG. 3.

Here, in the electrode assembly of a secondary battery wound by the above Equations 13 and 14/15 and 16/17 and 18/19 and 20, since both of the values of X and Y are integers, it is easy to adjust a dimension.

### Fourth Exemplary Embodiment

In an electrode assembly of a secondary battery according to a fourth exemplary embodiment of the present invention, first electrode tabs and second electrode tabs may be disposed in opposite directions on the different surfaces so as to be spaced apart from each other by a predetermined interval. In more detail, the first electrode tabs may be disposed on one side of a first surface, one side of a third surface, one side of a fifth surface, and so on, and the second electrode tabs may be disposed on the other side of a second surface, the other side of a fourth surface, and so on.

Here, the electrode assembly 100 of a secondary battery wound by the above Equation 11 and 12 is wound from one side thereof in a length direction, and is wound in a structure in which the first electrode tabs 110 are overlapped with each other on upper sides of one surfaces thereof and the second electrode tabs 120 are overlapped with each other on lower sides of the other surfaces, as shown in FIG. 4.

However, in the electrode assembly of a secondary battery wound by the above Equations 11 and 12, both of the values of X and Y may descend to a decimal point or less.

In addition, the electrode assembly 100 of a secondary battery wound by the above Equation 13 and 14 is wound from one side thereof in a length direction, and is wound in a structure in which the first electrode tabs 110 are overlapped with each other on upper sides of one surfaces thereof and the second electrode tabs 120 are overlapped with each other on lower sides of the other surfaces, as shown in FIG. 4.

In addition, the electrode assembly 100 of a secondary battery wound by the above Equation 15 and 16 is wound from one side thereof in a length direction, and is wound in a structure in which the first electrode tabs 110 are overlapped with each other on upper sides of one surfaces thereof and the second electrode tabs 120 are overlapped with each other on lower sides of the other surfaces, as shown in FIG. 4.

In addition, the electrode assembly 100 of a secondary battery wound by the above Equation 17 and 18 is wound from the other side thereof in a length direction, and is wound in a structure in which the first electrode tabs 110 are overlapped with each other on upper sides of one surfaces thereof and the second electrode tabs 120 are overlapped with each other on lower sides of the other surfaces, as shown in FIG. 4.

In addition, the electrode assembly 100 of a secondary battery wound by the above Equation 19 and 20 is wound from the other side thereof in a length direction, and is wound in a structure in which the first electrode tabs 110 are overlapped with each other on upper sides of one surfaces thereof and the second electrode tabs 120 are overlapped with each other on lower sides of the other surfaces, as shown in FIG. 4.

Here, in the electrode assembly of a secondary battery wound by the above Equations 13 and 14/15 and 16/17 and 18/19 and 20, since both of the values of X and Y are integers, it is easy to adjust a dimension.

Therefore, in the electrode assemblies of a secondary battery according to exemplary embodiments of the present invention, the first electrode tabs and the second electrode tabs may be easily stacked at desired positions, respectively.

The present invention is not limited to the above-mentioned exemplary embodiments, and may be variously applied, and may be variously modified without departing from the gist of the present invention claimed in the claims.

1. An electrode assembly of a secondary battery comprising first and second electrode plates sequentially stacked, and a first separator interposed between the first and second electrode plates, and the first and second electrode plates and the first separator are wound, wherein
the first electrode plate has one surface on which first electrode tabs are formed and an other surface on which the first electrode tabs are not formed,
the second electrode plate has one surface on which second electrode tabs are formed and an other surface on which the second electrode tabs are not formed, and
the first and second electrode plates further include a stacking surface formed between one surface and the other surface thereof and having a width increased by a predetermined interval whenever they are wound.

2. The electrode assembly of a secondary battery of claim 1, wherein the first electrode tabs and the second electrode tabs are disposed on the same surfaces so as to be spaced apart from each other by a predetermined interval.

3. The electrode assembly of a secondary battery of claim 1, wherein the first electrode tabs and the second electrode tabs are disposed on different surfaces so as to be spaced apart from each other by a predetermined interval.

4. The electrode assembly of a secondary battery of claim 1, wherein the first electrode tabs and the second electrode tabs are disposed in different directions on the same surfaces so as to be spaced apart from each other by a predetermined interval.

5. The electrode assembly of a secondary battery of claim 1, wherein the first electrode tabs and the second electrode tabs are disposed in opposite directions on different surfaces so as to be spaced apart from each other by a predetermined interval.

6. The electrode assembly of a secondary battery of claim 1, wherein a start position X at which the first electrode tab is formed in the first electrode plate is determined by the following Equation 1, and
a start position Y at which the second electrode tab is formed in the second electrode plate is determined by the following Equation 2:
X=nw+nt+d (n=0 to n) (Equation 1)
Y=mw+mt+(w−W2−d′) (m=0 to m) (Equation 2)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface formed at the time of initially winding electrode assembly of secondary battery to final position at which initial second electrode tab is formed
W2: width of second electrode tab
n, m: the number of windings.

7. The electrode assembly of a secondary battery of claim 1, wherein a start position X at which the first electrode tab is formed in the first electrode plate is determined by the following Equation 3, and
a start position Y at which the second electrode tab is formed in the second electrode plate is determined by the following Equation 4:
X=floor([nw+nt+d]/k) (n=0 to n) (Equation 3)
Y=floor([mw+mt+(w−W2−d′)]/k) (m=0 to m) (Equation 4)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

8. The electrode assembly of a secondary battery of claim 1, wherein a start position X at which the first electrode tab is formed in the first electrode plate is determined by the following Equation 5, and
a start position Y at which the second electrode tab is formed in the second electrode plate is determined by the following Equation 6:
X=ceil([nw+nt+d]/k) (n=0 to n) (Equation 5)
Y=ceil([mw+mt+(w−W2−d′)]/k) (m=0 to m) (Equation 6)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

9. The electrode assembly of a secondary battery of claim 1, wherein a start position X at which the first electrode tab is formed in the first electrode plate is determined by the following Equation 7, and
a start position Y at which the second electrode tab is formed in the second electrode plate is determined by the following Equation 8:
X=floor([nw+nt+d]/k) (n=n to 0) (Equation 7)
Y=floor([mw+mt+(w−W2−d′)]/k) (m=m to 0) (Equation 8)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

10. The electrode assembly of a secondary battery of claim 1, wherein a start position X at which the first electrode tab is formed in the first electrode plate is determined by the following Equation 9, and
a start position Y at which the second electrode tab is formed in the second electrode plate is determined by the following Equation 10:
X=ceil([nw+nt+d]/k) (n=n to 0) (Equation 9)
Y=ceil([mw+mt+(w−W2−d′)]/k) (m=m to 0) (Equation 10)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

11. The electrode assembly of a secondary battery of claim 1, wherein a start position X at which the first electrode tab is formed in the first electrode plate is determined by the following Equation 11, and
a start position Y at which the second electrode tab is formed in the second electrode plate is determined by the following Equation 12:
X=nw+nt+d (n=0 to n) (Equation 11)
Y=mw+mt+(w−W2−d′) (m=1 to m) (Equation 12)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings.

12. The electrode assembly of a secondary battery of claim 1, wherein a start position X at which the first electrode tab is formed in the first electrode plate is determined by the following Equation 13, and
a start position Y at which the second electrode tab is formed in the second electrode plate is determined by the following Equation 14:
X=floor([nw+nt+d]/k) (n=0 to n) (Equation 13)
Y=floor([mw+mt+(w−W2−d′)]/k) (m=1 to m) (Equation 14)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

13. The electrode assembly of a secondary battery of claim 1, wherein a start position X at which the first electrode tab is formed in the first electrode plate is determined by the following Equation 15, and
a start position Y at which the second electrode tab is formed in the second electrode plate is determined by the following Equation 16:
X=ceil([nw+nt+d]/k) (n=0 to n) (Equation 15)
Y=ceil([mw+mt+(w−W2−d′)]/k) (m=1 to m) (Equation 16)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.

14. The electrode assembly of a secondary battery of claim 1, wherein a start position X at which the first electrode tab is formed in the first electrode plate is determined by the following Equation 17, and
a start position Y at which the second electrode tab is formed in the second electrode plate is determined by the following Equation 18:
X=floor([nw+nt+d]/k) (n=n to 0) (Equation 17)
Y=floor([mw+mt+(w−W2−d′)]/k) (m=m to 1) (Equation 18)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
floor(x): maximum integer that is not larger than x.

15. The electrode assembly of a secondary battery of claim 1, wherein a start position X at which the first electrode tab is formed in the first electrode plate is determined by the following Equation 19, and
a start position Y at which the second electrode tab is formed in the second electrode plate is determined by the following Equation 20:
X=ceil([nw+nt+d]/k) (n=n to 0) (Equation 19)
Y=ceil([mw+mt+(w−W2−d′)]/k) (m=m to 1) (Equation 20)
w: unit winding width of electrode assembly of secondary battery
t: height of electrode assembly of secondary battery stacked at the time of winding electrode assembly of secondary battery once
d: distance from start position of first electrode plate to start position at which initial first electrode tab is formed
d′: distance from start position of initial stacking surface at the time of initially winding electrode assembly of secondary battery to final position at which initial second electrode tab is formed
W2: width of second electrode tab
n, m: the number of windings
k=integer between 2 to 5
ceil(x): minimum integer that is not smaller than x.
